(19) United States
(12) Patent Application Publication
(10) Pub. No.: US 2012/0147754 A1
(43) Pub. Date: Jun. 14, 2012

(54) HIGH-SPEED CONTENT INSPECTION APPARATUS FOR MINIMIZING SYSTEM OVERHEAD

(75) Inventors: Woo-Sug Jung, Daejeon-si (KR); Jong-Dae Park, Daejeon-si (KR); Byung-Ho Yae, Daejeon-si (KR); Sung-Kee Noh, Daejeon-si (KR); Sung-Jin Moon, Daejeon-si (KR); Nam-Seok Ko, Daejeon-si (KR); Hwan-Jo Heo, Daejeon-si (KR)

(73) Assignee: ELECTRONICS AND TELELCOMMUNICATIONS RESEARCH INSTITUTE, Dajeon-si (KR)

(21) Appl. No.: 13/324,416

(22) Filed: Dec. 13, 2011

(30) Foreign Application Priority Data
Dec. 14, 2010 (KR) 10-2010-0127744

(51) Int. Cl. H04J 3/14

(52) U.S. Cl. 370/242

(57) ABSTRACT

A high-speed content inspection apparatus for minimizing system overhead is provided. The high-speed content inspection apparatus extracts content in unit of sub-pattern by inspecting a payload of a packet in units of sub-pattern, and extract target content by inspecting a correlation between the extracted sub-patterns. If a sub-pattern present at the end of a payload is smaller than a predetermined unit of a sub-pattern, position information of the sub-pattern at the end of the payload is rolled back and the correlation is inspected. Accordingly, without having to add another hardware or high-performance hardware, target content can be efficiently detected in real time.

### CROSS-REFERENCE TO RELATED APPLICATION(S)

This application claims the benefit under 35 U.S.C. §119(a) of Korean Patent Application No. 10-2010-0127744, filed on Dec. 14, 2010, in the Korean Intellectual Property Office, the entire disclosure of which is incorporated herein by reference for all purposes.

### BACKGROUND

1. Field

The following description relates to a content inspection technology, and more particularly, to a high-speed content inspection apparatus capable of minimizing system overhead generated in the course of content inspection on out-of-sequence packets.

2. Description of the Related Art

Recent demands of Internet users are varied from services over a best-effort network, such as web surfing services and file transmission, to maintaining consistent service quality such as required in Voice over Internet Protocol (VoIP) services.

Packets related to services such as VoIP services that have to be offered in real time should be transmitted at a constant packet transmission rate to ensure consistent service quality. For example, packets of a VoIP service that requires a constant transmission delay time may have higher priority than other packets related to, for example, web surfing which does not have to be transmitted in real time. To classify packets according to a type of service, inspection needs to be performed on a payload of a packet as well as a header.

Generally, in detecting target content from out-of-sequenced packets that are delivered without a predetermined order, rearrangement and reassembly of packets by buffering the packets should be performed, which requires additional memory and a high-performance processor. This may result in increase in a system cost and may cause performance degradation in a system. Thus, there is a need for a technology capable of quickly inspecting target content without an additional memory and high-performance processor.

### SUMMARY

The following description relates to a high-speed content inspection apparatus capable of detecting target content quickly without having to adding additional memory and a high-performance processor, and thereby improving performance in content inspection, and also minimizing system overhead.

In one general aspect, there is provided a high-speed content inspection apparatus for minimizing system overhead, the high-speed content inspection apparatus configured to extract sub-patterns by inspecting a payload of a packet in units of sub-pattern, to extract target content by inspecting a correlation between extracted sub-patterns, and to store position information of each of sub-patterns required for inspecting a correlation between the sub-patterns.

The high-speed content inspection apparatus may be further configured to extract the sub-patterns by inspecting a sub-pattern table that stores sub-patterns in a matrix form.

The high-speed content inspection apparatus may be further configured to generate the row-shift information when data at the end of the payload which is to be compared with the sub-patterns present in the sub-pattern table is smaller than a unit of the sub-pattern.

Other features and aspects may be apparent from the following detailed description, the drawings, and the claims.

### BRIEF DESCRIPTION OF THE DRAWINGS

FIG. 1 is a diagram illustrating an example of a high-speed content inspection apparatus for minimizing system overhead.

FIG. 2 is a diagram illustrating an example of the content inspection unit of a high-speed content inspection apparatus for minimizing system overhead.

FIG. 3 is a diagram illustrating an example of how to extract a sub-pattern from a sub-pattern table storing sub-patterns in a matrix form.

FIG. 4 is a diagram illustrating an example of the sub-pattern extraction unit of a high-speed content inspection apparatus for minimizing system overhead.

FIG. 5 is a diagram illustrating an example of a row-shift calculation unit of a high-speed content inspection apparatus for minimizing system overhead.

FIG. 6 is a diagram illustrating an example of a packet inspection apparatus to which the high-speed content inspection apparatus for minimizing system overhead as illustrated in the above examples.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

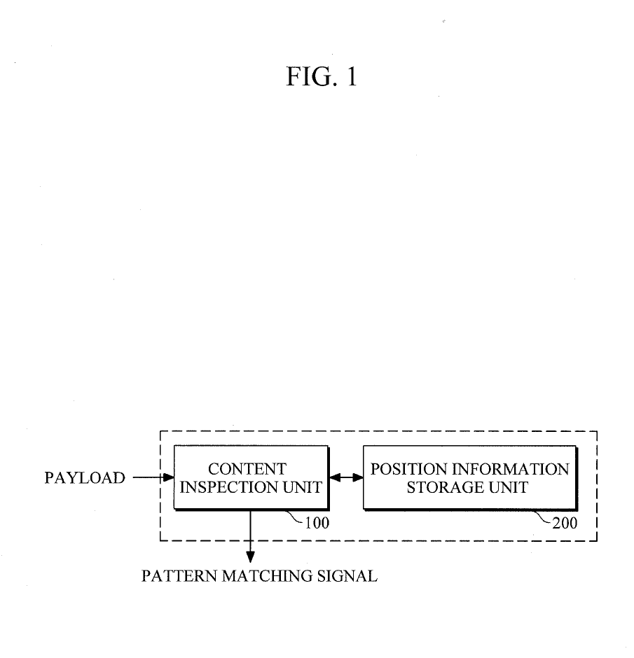

FIG. 1 is a diagram illustrating an example of a high-speed content inspection apparatus for minimizing system overhead. Referring to FIG. 1, high-speed content inspection apparatus may include a content inspecting unit 100 and a position information storage unit 200.

The content inspection unit 100 may inspect payloads of packets in units of sub-pattern to extract sub-patterns, and inspect the correlation between the extracted sub-patterns to detect target content. For example, the sub-pattern may be formed in units of predetermined bytes.

In this case, the content inspection unit 100 may inspect all combinations of data that may correspond to target content from multiple packets, that is, inspect a sub-pattern table that has previously stored sub-patterns in a matrix form, and thereby extract the sub-patterns.

In addition, in inspecting the correlation between the sub-patterns, the content inspection unit 100 may determine that target content is detected when all sub-patterns stored in the sub-pattern table are extracted from payloads of packets while maintaining the predetermined combination order thereof. The sub-pattern extraction and correlation inspection will be described in detail later.

The position information storage unit 200 may store position information of sub-patterns required by the content inspection unit 100 to inspect the correlation between the sub-patterns. That is, the position information storage unit 200 may receive position information required for inspecting the correlation between the sub-patterns from the content inspection unit 100, and store the received information in an internal memory.

The position information of the sub-patterns required for the correlation inspection may include first position information, second position information, third position information, and fourth position information. The first position information indicates at which position the extracted sub-pattern is located in payload. The second position information indicates the order of packet from which sub-pattern has been extracted. The third position information indicates that the sub-pattern is extracted from the front of a packet, and the fourth position information indicates that the sub-pattern is extracted from the rear of the packet.

The position information of the sub-patterns is used in determining whether all sub-patterns are extracted from payload of a packet while maintaining the predetermined combination order during the content inspection unit 100 inspects the correlation between the sub-patterns. The creation of the position information of extracted sub-patterns will be described in detail later.

Accordingly, it is possible to detect target content by extracting sub-patterns from payload of a packet and inspecting the correlation between the sub-patterns with reference to a sub-pattern table that stores sub-patterns in a matrix form. For example, the target content may be particular data related to a service or malicious hacking code, such as worm virus or a backdoor program.

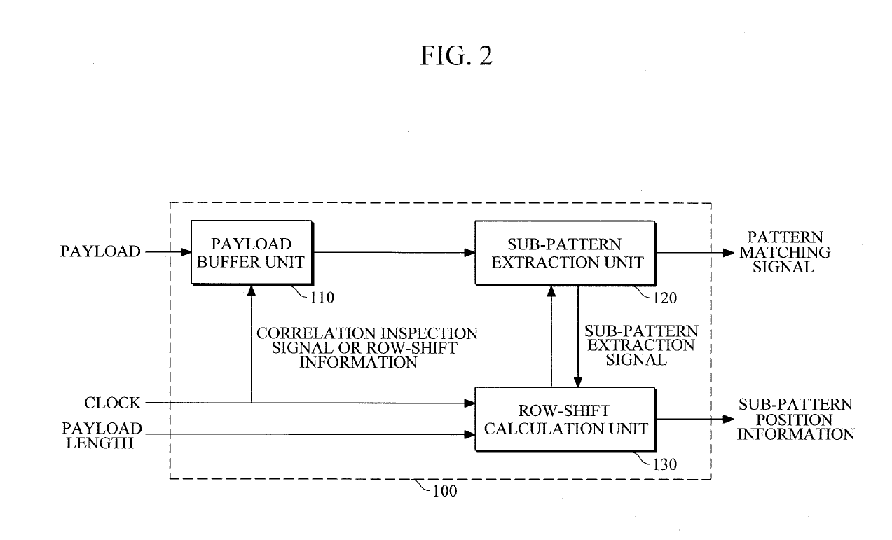

In one aspect, as shown in FIG. 2, the content inspection unit 100 may include a payload buffer unit 110, a sub-pattern extraction unit 120, and a row-shift calculation unit 130. FIG. 2 is a diagram illustrating an example of the content inspection unit of a high-speed content inspection apparatus for minimizing system overhead.

The payload buffer unit 110 may fetch payload of a packet in units of sub-pattern. In this case, the payload buffer unit 110 may fetch the payload of a packet in units of predetermined bytes. For example, the payload buffer unit 110 may be implemented as an n-byte shift register.

The sub-pattern extraction unit 120 may compare pieces of data fetched in units of sub-pattern with sub-patterns stored in a sub-pattern table and extract sub-patterns, and inspect correlation between the extracted sub-patterns. Consequently, the sub-pattern extraction unit 120 can detect target content.

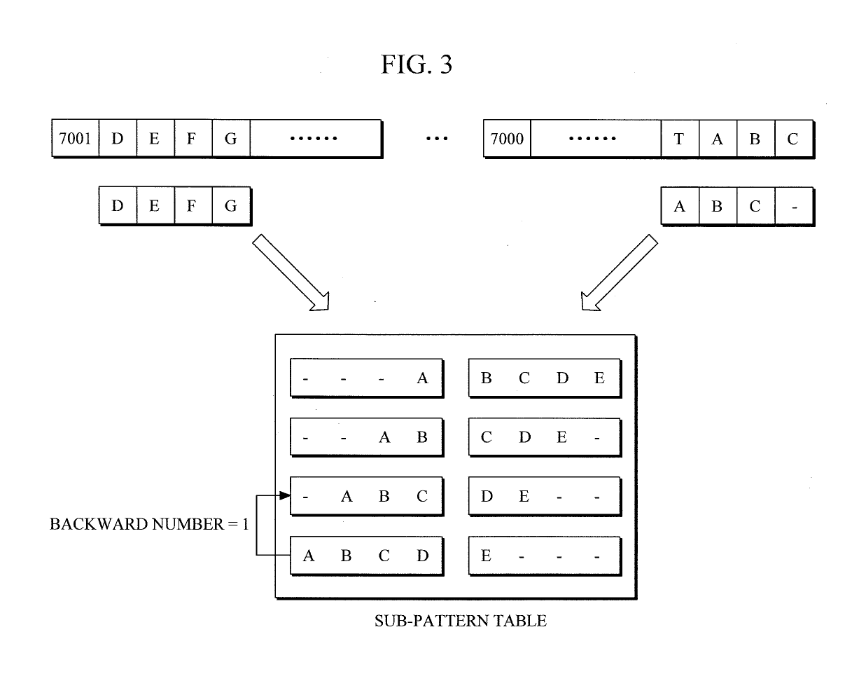

FIG. 3 is a diagram illustrating an example of how to extract a sub-pattern from a sub-pattern table storing sub-patterns in a matrix form. The example shown in FIG. 3 assumes that payload of a packet is fetched in units of four bytes.

In FIG. 3, ‘7000’ and ‘7001’ represent sequence numbers indicating the orders of packets, and ‘-’ represents a ‘don't care’ identifier indicating a “don't care” state of sub-pattern data in the sub-pattern table.

If target content is ‘ABCDE,’ in extracting one byte by one byte, ‘D E - -’ and ‘E - - -’ are extracted from payload of a packet having ‘7001’ as a sequence number and ‘- - A,’ ‘- - A B’ and ‘- A B C’ are extracted from payload of a packet having ‘7000’ as a sequence number.

‘- A B C’ and ‘D E - -’ that constitute the third row of a sub-pattern matrix in the sub-pattern table are all extracted, and thus the target content, ‘A B C D E,’ is found in the payloads of the packets having ‘7000’ and ‘7001’ as the sequence number through the correlation inspection.

However, in inspecting the payload one byte by one byte, the inspection takes long time due to the number of times of inspection. The overall content inspection speed is dependent on the inspection speed, resulting in increase of time for detecting the target content.

To solve the above drawbacks, payload is required to be inspected in units of sub-pattern consisting of n bytes. If the length of payload data to be inspected is smaller than n bytes of a sub-pattern, there may be a problem that target content cannot be detected even when all sub-patterns are extracted for correlation inspection.

For example, in inspecting the packet having sequence number ‘7000’ in units of 4 bytes, if garbage data is added to the last payload data, which is ‘A B C’, to make the data 4 bytes, it is not possible to extract a sub-pattern.

If ‘-’ is added to the remaining payload data ‘A B C,’ it is possible to extract ‘A B C D’, but ‘D E - -’ is extracted from the packet with sequence number ‘7001.’ Thus, not all sub-patterns that constitute a row of the sub-pattern table are extracted, and hence it is not possible to extract the target content ‘A B C D E.’

Such problems may be solved by the row-shift calculation unit 130. The row-shift calculation unit 130 may generate a correlation inspection signal or row-shift information for detecting a sub-pattern from an end of payload, and transmit the generated information to the sub-pattern extraction unit 120.

For example, in response to all sub-patterns in the sub-pattern table being extracted, the row-shift calculation unit 130 may generate a correlation inspection signal and transmit the generated signal to the sub-pattern extraction unit 120. When data at the end of the payload to be compared with the sub-patterns present in the sub-pattern table is smaller than the unit of a sub-pattern, the row-shift calculation unit 130 may generate row-shift information and transmit the generated information to the sub-pattern extraction unit 120.

If the data at the end of the payload to be compared with the sub-patterns present in the sub-pattern table is smaller than the unit of the sub-pattern, the row-shift calculation unit 130 may add as many ‘-’ to the data to make up for the difference between the data and the unit of the sub-pattern, and then shift a position of a row to a lower position in the sub-pattern table according to the number of the added ‘-.’ The number of roll-backs is referred to a backward number. The row-shift calculation unit 130 may calculate a backward number and generate the row-shift information.

Referring to FIG. 3, if a length of the sub-pattern is 4 bytes and a length of data at the end of a payload is 3 bytes, as many ‘don't care’ identifiers ‘-’ as 1 byte are added to the data. Then, when ‘A B C D’ which is present in the fourth row of the sub-pattern table has been extracted, a determination is made that ‘- A B C’ is extracted, which is included in the third row. This has an effect that the payload is inspected from the end when the end of the payload has a part of content.

Since ‘D E - -’ is extracted from the packet with sequence number ‘7001,’ the extracted ‘- A B C’ and the ‘D E - -’ are the same as the combination of sub-patterns extracted in byte-per-byte inspection. It indicates that target content can be detected even through inspection in units of n bytes.

Thus, it is possible to efficiently detect target content in real time in inspecting multiple packets including out-of-sequence packets without additional hardware and high-performance hardware. Accordingly, the content detection performance and service quality can be improved.

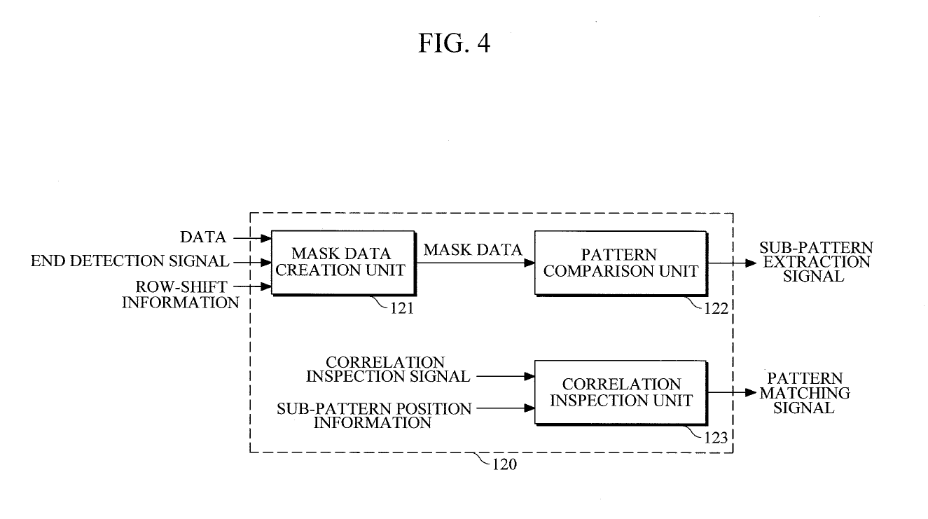

FIG. 4 is a diagram illustrating an example of the sub-pattern extraction unit of a high-speed content inspection apparatus for minimizing system overhead. Referring to FIG. 4, sub-pattern inspection unit 120 may include a mask data creation unit 121, a pattern comparison unit 122, and a correlation inspection unit 123.

The mask data creation unit 121 may create mask data for use in inspecting a payload of a packet in units of sub-pattern. If a length of a sub-pattern is n bytes and data at the end of a payload is smaller than n bytes, the mask data creation unit 121 may create mask data to fill the short data with ‘don't care’ identifiers ‘-’, such that the data can be compared with each of sub-patterns present in a sub-pattern table.

For example, in response to an end detection signal being activated, which indicates that data including target content is located at the end of a payload, the mask data creation unit 121 may fill as many ‘don't care’ identifiers ‘-’ as a forward number in the data to create mask data.

A bus width of the forward number is (n−1) bytes, and the bus width of each of the data and mask data is n bytes. In response to an inactivated end detection signal, the data is mapped to the mask data.

The pattern comparison unit 122 may compare the mask data created by the mask data creation unit 121 with sub-patterns present in a sub-pattern table, and extract sub-patterns. The pattern comparison unit 122 may activate a sub-pattern extraction signal when the same sub-pattern as the mask data is present in the sub-pattern table.

The correlation inspection unit 123 may calculate a correlation between the extracted sub-patterns using position information of the sub-patterns. Based on the calculation result, the correlation inspection unit 123 may determine whether the combination of the sub-patterns is the same as target content. In response to the reception of a correlation inspection execution signal from the row-shift calculation unit 130, the correlation inspection unit 123 may inspect the correlation between the sub-patterns, and activate a pattern matching signal if the combination of the extracted sub-patterns is the same as target content.

In this case the correlation inspection unit 123 may inspect the correlation between the sub-patterns with reference to first position information, second position information, third position information, and fourth position information which are stored in the position information storage unit 200. The first position information indicates a position of the extracted sub-pattern in a payload, the second position information indicates an order of a packet from which the sub-pattern has been extracted, the third position information indicates that the sub-pattern is extracted from a front of a packet, and the fourth position information indicates that the sub-pattern is extracted from an end of a packet.

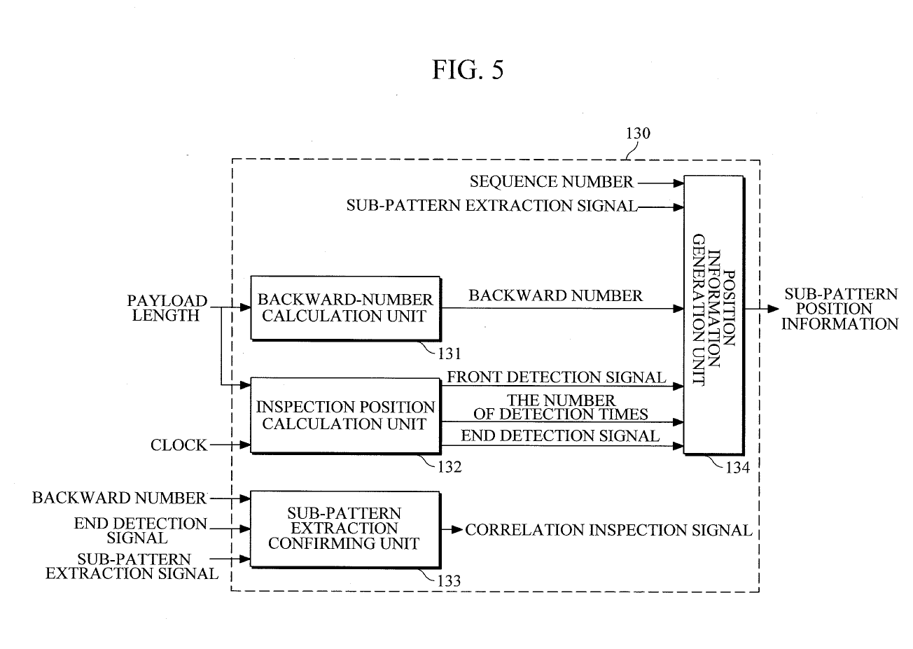

FIG. 5 is a diagram illustrating an example of a row-shift calculation unit of a high-speed content inspection apparatus for minimizing system overhead. Referring to FIG. 5 row-shift calculation unit 130 may include a backward-number calculation unit 131, an inspection position calculation unit 132, a sub-pattern extraction confirming unit 133, and a position information generation unit 134.

The backward-number calculation unit 131 may calculate a backward number and generate row-shift information. The backward-number calculation unit 131 may calculate the backward number using a payload length. The backward number refers to the number of roll backs in the sub-pattern table, and is a remainder after division of the payload length by a unit of the sub-pattern. The backward number may be calculated by the equation as below.

Backward number=Payload length % n,

where n is a length of a sub-pattern, indicating the amount of payload data that can be searched at one time. The backward-number calculation unit 131 may transmit the calculated backward number to the sub-pattern extracting confirming unit 133 and the position information generation unit 134.

The inspection position calculation unit 132 may calculate a position of sub-pattern unit data in a payload. For example, the inspection position calculation unit 132 may be implemented as a counter of which a maximum value is set to a value obtained by adding 1 to a result of division of the payload length by the sub-pattern length.

If a sub-pattern is extracted at the first extraction attempt, the inspection position calculation unit 132 may activate a front detection signal. If a sub-pattern is extracted at the last extraction attempt that corresponds to the maximum value, the inspection position calculation unit 132 may activate an end detection signal. The number of detection times indicates the number of attempts to extract a sub-pattern. In this case, the front detection signal and the end detection signal have higher priority than that of the number of detection times, and the priorities of such information is applied to the position information generation unit 134.

The sub-pattern extraction confirming unit 133 may determine whether all sub-patterns have been extracted or not. The sub-pattern extraction confirming unit 133 may generate a correlation inspection execution signal. Based on the sub-pattern extraction signal from the sub-pattern inspection unit 120 to indicate the occurrence of extraction of a sub-pattern and the end detection signal activated by the inspection position calculation unit 132, the sub-pattern extraction confirming unit 133 determines whether all sub-patterns have been extracted.

In response to the determination being made that all sub-patterns have been extracted and the backward number being obtained by the backward-number calculation unit 131, the sub-pattern extraction confirming unit 133 may generate the correlation inspection execution signal and transmit it to the sub-pattern inspection unit 120. In response to the correlation inspection execution signal, the sub-pattern inspection unit 120 inspects the correlation between the extracted sub-patterns.

The position information generation unit 134 may generate position information of the extracted position information. In response to the sub-pattern extraction signal activated by the sub-pattern inspection unit 120 to indicate that a sub-pattern has been extracted, the position information generation unit 134 may generate position information of sub-patterns for use in inspecting the correlation between the sub-patterns using the sequence number indicating the packet order of the sub-pattern, the backward number calculated by the backward-number calculation unit 131, and the number of detection times, the front detection signal and the end detection signal activated by the inspection position calculation unit 132. The position information generation unit 134 may store the generated position information in the position information storage unit 200.

When a determination is made that a sub-pattern is located in the end of a payload based on the sequence number, the number of detection times, and the end detection signal and the sub-pattern is smaller than the unit of a sub-pattern, the position information generation unit 134 rolls back the position information of the sub-pattern as many times as the backward number, and generates the corresponding position information of the sub-pattern.

For example, as shown in FIG. 3, if a sub-pattern currently being extracted from the end of a payload is related to the fourth row of the sub-pattern table, and a backward number is 1, position information of the sub-pattern is rolled back to the third row of the sub-pattern table.

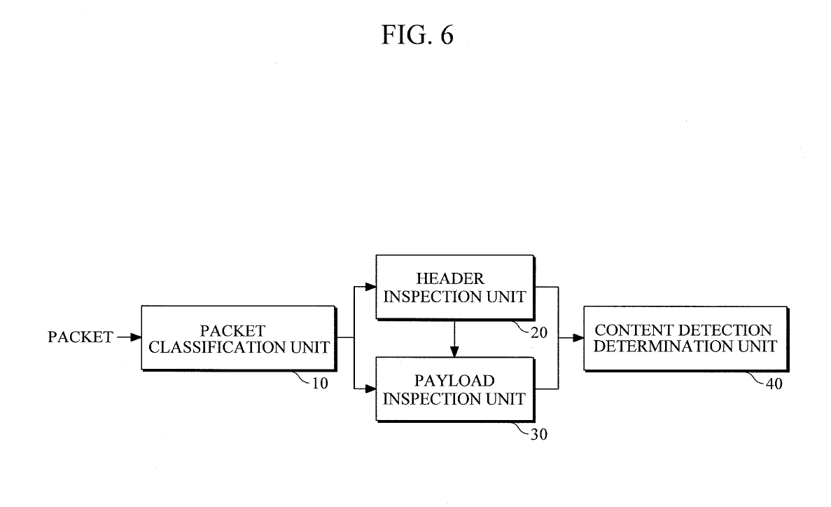

FIG. 6 is a diagram illustrating an example of a packet inspection apparatus to which the high-speed content inspection apparatus for minimizing system overhead as illustrated in the above examples. Referring to FIG. 6, packet inspection apparatus may include a packet classification unit 10, a header inspection unit 20, a payload inspection unit 30, and a content detection determination unit 40.

The packet classification unit 10 may classify packets. The header inspection unit 20 may inspect a header of the classified packet. The payload inspection unit 30 may inspect a payload of the classified packet. The content detection determination unit 40 may determine whether the content has been detected based on the results from the header inspection unit 20 and the payload inspection unit 30. The payload inspection unit 30 may be equipped with the high-speed content inspection apparatus illustrated in the above examples.

Accordingly, in inspecting a sub-pattern which is located at the end of a payload and is smaller than a unit of the sub-pattern, position information of the sub-pattern at the end of a payload is rolled back as many times as a backward number. Based on the rolled-back position information, a correlation between the sub-patterns is inspected. Consequently, without having to add another hardware or high-performance hardware, target content can be effectively inspected in real time, so that the content detection performance and a service quality can be improved. Further, malicious contents such as worms, viruses and backdoor programs can be effectively prevented.

Accordingly, it is possible to inspect content of a large amount of data at one time, and thus a service quality in a high-speed network can be ensured. In addition, system overhead incurred during content inspection on out-of-sequence packet can be minimized, and thereby a high-performance content inspection apparatus can be implemented with less cost.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A high-speed content inspection apparatus for minimizing system overhead, comprising:
a content inspection unit configured to extract sub-patterns by inspecting a payload of a packet in units of sub-pattern and extract target content by inspecting a correlation between extracted sub-patterns;
a position information storage unit configured to store position information of each of sub-patterns required for inspecting a correlation between the sub-patterns.

2. The high-speed content inspection apparatus of claim 1, wherein the content inspection unit is further configured to extract the sub-patterns by inspecting a sub-pattern table that stores sub-patterns in a matrix form.

3. The high-speed content inspection apparatus of claim 2, wherein the content inspection unit is further configured to inspect the correlation between the sub-patterns by determining that the target content is detected when all sub-patterns stored in the sub-pattern table are extracted from a payload of a packet while maintaining a predetermined combination order thereof.

4. The high-speed content inspection apparatus of claim 1, wherein the position information includes first position information that indicates a position of the extracted sub-pattern is located in the payload, second position information that indicates an order of the packet from which the sub-pattern has been extracted, third position information that indicates that the sub-pattern has been extracted from a front of the packet, and fourth position information that indicates that the sub-pattern has been extracted from an end of the packet.

5. The high-speed content inspection apparatus of claim 3, wherein the content inspection unit is further configured to comprise
a payload buffer unit configured to fetch the payload of the packet in units of sub-pattern,
a sub-pattern inspection unit configured to extract the sub-patterns by comparing data fetched in units of sub-pattern by the payload buffer with the sub-patterns present in the sub-pattern table and extract the target content by inspecting the correlation between the extracted sub-patterns, and
a row-shift calculation unit configured to generate a correlation inspection signal or row-shift information for detecting a sub-pattern from an end of a payload and transmit the generated correlation inspection signal or row-shift information to the sub-pattern inspection unit.

6. The high-speed content inspection apparatus of claim 5, wherein the row-shift calculation unit is further configured to generate the correlation inspection signal when all sub-patterns present in the sub-pattern table have been extracted.

7. The high-speed content inspection apparatus of claim 5, wherein the row-shift calculation unit is further configured to generate the row-shift information when data at the end of the payload which is to be compared with the sub-patterns present in the sub-pattern table is smaller than a unit of the sub-pattern.

8. The high-speed content inspection apparatus of claim 7, wherein when the data at the end of the payload which is to be compared with the sub-patterns present in the sub-pattern table is smaller than the unit of the sub-pattern, the row-shift calculation unit is further configured to add a number of “don't care” identifiers in the data to make up for the difference between the data and the unit of the sub-pattern, and shift a position of a row to a lower position in the sub-pattern table according to the number of added identifiers.

9. The high-speed content inspection apparatus of claim 5, wherein the sub-pattern inspection unit is further configured to comprise
a mask data creation unit configured to create mask data to inspect the payload of the packet in units of sub-pattern,
a pattern comparison unit configured to extract the sub-patterns by comparing the mask data generated by the mask data creation unit with the sub-patterns present in the sub-pattern table, and
a correlation inspection unit configured to determine whether a combination of the sub-patterns is the same as the target content by calculating the correlation between the sub-patterns using position information of the extracted sub-patterns.

10. The high-speed content inspection apparatus of claim 9, wherein the mask data creation unit is further configured to create the mask data to fill a difference between the data at the end of the payload which is smaller than the unit of the sub-pattern and the unit of the sub-pattern with “don't care” identifiers ‘-’ so as to compare the data with the sub-pattern table.

11. The high-speed content inspection apparatus of claim 5, wherein the row-shift calculation unit is further configured to comprise
a backward number calculation unit configured to calculate a backward number and generate the row-shift information,
an inspection position calculation unit configured to calculate a position of sub-pattern unit data present in the payload,
a sub-pattern extraction confirming unit configured to determine whether all sub-patterns have been extracted or not, and
a position information generation unit configured to generate the position information of the extracted sub-patterns.

12. The high-speed content inspection apparatus of claim 11, wherein the backward number calculation unit is further configured to set a remainder after division of a payload length by a unit of the sub-pattern as the backward number.

13. The high-speed content inspection apparatus of claim 11, wherein the sub-pattern extraction confirming unit is further configured to generate a correlation inspection signal in response to a determination being made that all sub-patterns have been extracted and the backward calculation unit calculating the backward number.

14. The high-speed content inspection apparatus of claim 11, wherein the position information generation unit is further configured to roll back position information of a sub-pattern present at an end of a corresponding payload as many as the backward number when the sub-pattern is determined as being at the end of the payload and the sub-pattern is smaller than a predetermined unit of a sub-pattern.
